(19) United States
(12) Patent Application Publication
(10) Pub. No.: US 2016/0318366 A1
(43) Pub. Date: Nov. 3, 2016

(54) CHASSIS DEVICE FOR THE SUSPENSION SYSTEM OF A WHEEL SUSPENSION OF A CHASSIS OF A VEHICLE

(71) Applicant: Dr. Ing. h.c. F. Porsche Aktiengesellschaft, Stuttgart (DE)

(72) Inventor: Michael Baum, Tiefenbronn-Lehningen (DE)

(21) Appl. No.: 15/058,776

(22) Filed: Mar. 2, 2016

(30) Foreign Application Priority Data
Apr. 28, 2015 (DE) 102015106513.4

(51) Int. Cl. B60G 17/08; B60G 15/12; B60G 11/56

(52) U.S. Cl. CPC B60G 17/08; B60G 11/56; B60G 15/12; B60G 2202/312; B60G 2202/24; B60G 2600/22; B60G 2800/162

(57) ABSTRACT

A chassis device for the suspension system of a wheel suspension of a chassis of a vehicle, having a pneumatic suspension system with a pneumatic spring chamber for receiving a compressed air filling, wherein a mechanical spring device is arranged in the pneumatic spring chamber, with a first connecting section, which is supported against a first countersection of the pneumatic spring chamber, and with a second connecting section, which is supported against a second countersection of the pneumatic spring chamber, wherein at least one of the two countersections has a switching section which is designed for varying the force absorption by the connecting section.

### CROSS-REFERENCE TO RELATED APPLICATION

This application claims priority to German Patent Application No. DE 10 2015 106 513.4, filed Apr. 28, 2015, which is incorporated by reference herein in its entirety.

### FIELD OF THE INVENTION

The present invention relates to a chassis device for the suspension system of a wheel suspension of a chassis of a vehicle, and to a method for changing the chassis characteristics of a chassis of a vehicle.

### BACKGROUND OF THE INVENTION

It is known that vehicles are equipped with different chassis depending on the use situation of the vehicles. In particular, two use differences can be encountered here. Firstly, there are vehicles or drivers placing high value on comfortable driving. Secondly, there are drivers or vehicles placing high value on sporty driving. These two fundamental use differences, which can be referred to as comfort or sport, differ in the chassis region in particular by the selection of the corresponding suspension system device or the chassis device. Comfort-oriented vehicles are frequently equipped with pneumatic suspension making it possible to provide a particularly comfortable suspension system comfort for the vehicle. Sports vehicles are customarily equipped with steel springs in order to ensure the desired sporty chassis characteristics.

A disadvantage of the known solutions is that a combination of sporty and comfortable properties of a chassis customarily entails contrary properties and is therefore not possible. The previously presented solutions of complicated valve arrangements on individual spring steel solutions for varying between comfort settings and sports settings constitute a solution which is possible, but is still unsatisfactory in terms of the breadth of variation possibility.

### SUMMARY OF THE INVENTION

Described herein is a chassis device that at least partially eliminates the above-described disadvantages. In particular, the chassis device described herein permits as flexible a switchability as possible between sporty and comfortable chassis characteristics of a chassis in a cost-effective and simple manner.

Here, features and details which are described in connection with the chassis device according to aspects of the invention also apply, of course, in connection with the method according to aspects of the invention and vice versa in each case, and therefore reciprocal reference is or can always be made as regards the disclosure of the individual aspects of the invention.

A chassis device according to aspects of the invention for the suspension system of a wheel suspension of a chassis of a vehicle has a pneumatic suspension system. Said pneumatic suspension system is equipped with a pneumatic spring chamber which is designed for receiving a compressed air filling. Furthermore, a chassis device according to aspects of the invention is distinguished in that a mechanical spring device is arranged in the pneumatic spring chamber. Said mechanical spring device is equipped with a first connecting section, which is supported against a first countersection of the pneumatic spring chamber. Furthermore, the mechanical spring device is equipped with a second connecting section, which is supported against a second countersection of the pneumatic spring chamber. At least one of the two countersections is equipped with a switching section which is designed for varying the force absorption by the connecting section.

A chassis device according to aspects of the invention is therefore based on the fundamentally known pneumatic suspension systems. A pneumatic suspension system is thus also provided here, which can provide fundamental and particularly comfortable chassis tuning by means of a pneumatic spring chamber with a corresponding compressed air filling. In order now to be able to provide a sporty chassis character in a manner according to aspects of the invention even in the case of a pneumatic suspension system, the pneumatic suspension system is developed to the effect that a mechanical spring device is now arranged within the pneumatic spring chamber.

A mechanical spring device should be understood within the context of the present invention as meaning any form of a spring device which can obtain a spring effect by changing the geometrical dimensions thereof and, accordingly, an available elasticity of the spring device component. In particular, a spiral spring or steel spring is involved here as is explained in more detail further on.

In order also to be able to transmit the corresponding spring effect of the mechanical spring device to the wheel suspension, the spring device is equipped with at least two connecting sections. Said connecting sections, for example, can be spring plates or can have spring plates which are located arranged at the upper and at the lower end of the spring device. It is therefore possible for the spring device to be braced via the two connecting sections within the pneumatic chamber for force absorption counter to both directions. In other words, force can now be introduced from the wheel suspension into the spring device via the countersection of the pneumatic spring chamber and the connecting section of the spring device. At the opposite end of the spring device, said force is transferred via the first connecting section and the first countersection to the pneumatic chamber again and is transmitted from there into the vehicle. The mechanical spring device can therefore be arranged as part of the force path between the road and the chassis of the vehicle via the correlation of the connecting sections with the counter connecting sections.

A core concept according to aspects of the invention is now to design the above-described efficacy of the arrangement in the force path for the mechanical spring device to be switchable. This is ensured by the switching section which now no longer acts directly on the pneumatic suspension system or the mechanical spring device, but rather influences the efficacy of the force path. This is made possible by the fact that the switching section acts on the respective countersection and varies the elasticity or the possibility of the force absorption by the connecting section there. This should be understood as meaning in particular that the force absorption is switched on and off. One possibility of such an embodiment is if a fluid which can take up different elastic configurations is accommodated in a corresponding switching space. For example, use can be made of a magnetizable fluid (explained in more detail further on) which, under the effect of a magnetic field, has a high resistance force and, correspondingly, low elasticity. If an action of the magnetic field is missing, such a magnetizable fluid can be provided with high elasticity and therefore with a low resistance force.

As is apparent from the above explanation, the fundamental capability for force absorption by the connecting section can now be switched by means of the switching section for the respective countersection. The force absorption is therefore switched on if an arrangement of the mechanical spring device in the force path is desired. When the switching section is switched on, this leads to the chassis characteristics being supported on at least parts of the mechanical spring device. In other words, sporty chassis characteristics are thereby possible, and therefore the characteristics of a classic steel spring chassis can be substantially provided.

If, by contrast, the switching section is switched off and therefore the mechanical spring device is removed from the force path by the increase in the elasticity and therefore the reduction in the force absorption possibility, the suspension quality of the chassis of the vehicle is substantially exclusively or for the most part based on the pneumatic suspension.

As is now apparent, switching over between two general chassis settings can take place without any mechanical influencing of the actually acting spring functions, i.e. the pneumatic suspension or the mechanical spring device. This is no longer now a compromise which adjusts a pneumatic suspension system into the range of a steel suspension system or configures a steel suspension system to be particularly comfortable, but rather an actual switching over takes place between two actually fundamentally contrary chassis orientations. In other words, a chassis device according to aspects of the invention can be referred to as a combined steel spring and pneumatic spring chassis.

Diverse advantages can be obtained by the design according to aspects of the invention of a chassis device. In particular, it is thereby possible to switch over between a steel spring chassis and a pneumatic spring chassis by pushing a button. The breadth in variation in respect of the chassis characteristics is significantly greater here than would be possible at all in the event of an adaptation of a single chassis configuration to a correspondingly desired driving mode. Furthermore, chassis-typical components, for example the height variation in the case of a pneumatic suspension system, can be combined as desired here with steel spring characteristics of a chassis.

It can be of advantage if, in the case of a chassis device according to aspects of the invention, the mechanical spring device is designed as a spiral spring, in particular as a steel spring. A spiral spring, in particular in the form of a steel spring, constitutes a particularly simple and cost-effective solution. Furthermore, small dimensions are possible here, and therefore the space requirement of the entire system of a chassis device according to aspects of the invention can be significantly reduced. Of course, however, other materials than steel or other geometrical configurations than a spiral spring are fundamentally conceivable for the mechanical spring device within the context of the present invention.

It is likewise of advantage if, in the case of a chassis device according to aspects of the invention, the at least one switching section has a switching space which is filled with a fluid, the elasticity of which is variable. As has already been described in the introduction, the switching section with a switching space is a particularly simple and cost-effective embodiment. A fluid here can be a liquid and/or a gas. Mixtures of different fluids are also conceivable within the context of the present invention. Of course, solid particles can also be dissolved or accommodated in the respective fluid. By varying the elasticity, the force absorption switching described according to aspects of the invention and a corresponding variation of the arrangement of the mechanical spring device in the force transmission path can take place. In addition to the variant of the use of a magnetizable liquid, which has already been explained and which is described in more detail in the following paragraph, compressible fluids can also be accommodated within the context of the present invention in the switching space. For example, a filling with a gas under high pressure can take place such that the compressibility is thereby reduced, the resistance force is increased and therefore the effect of the mechanical spring device in the force path is reinforced. Conversely, the reduction in the pressure by letting fluid out of the switching space will cause a corresponding, opposing effect.

It is likewise advantageous if, in the case of a chassis device according to aspects of the invention, the switching space is filled with a magnetizable liquid having ferromagnetic particles, wherein the ferromagnetic particles are aligned under the effect of a magnetic field and change the elasticity of the magnetizable liquid. A magnetizable liquid here can be both a pure liquid and a suspension in which solid particles as ferromagnetic particles are suspended. By application of a magnetic field, in particular by an electromagnetic coil, the orientation of said particles can be changed in such a manner that the compressibility or the yielding behavior of the magnetizable liquid significantly changes. In particular, recourse can also be made here to a combination of a gas and the magnetizable liquid such that correspondingly, when the magnetic field is switched on, the elasticity drops virtually to zero and the liquid which is magnetized in this manner substantially behaves like a solid. This leads to a particularly simple and especially cost-effective solution in order to be able to provide the switching section.

It is furthermore advantageous if, in the case of a chassis device according to aspects of the invention, the at least one switching section has an electromagnetic coil device for generating a magnetic field for effect on the magnetizable liquid accommodated in the switching space. The coil device here is a further indication of the fact that the use of magnetizable liquids affords particularly great cost advantages. It is a particularly lightweight embodiment which can provide the switching function. In particular, a corresponding design of the switching section on both sides of the mechanical spring device is provided, and therefore the electromagnetic coil device can be controlled, regulated or monitored on the basis of a single regulating source, monitoring source or voltage or current source.

It is likewise advantageous if, in the case of a chassis device according to aspects of the invention, each of the countersections has a dedicated switching section, wherein the switching sections are preferably of identical or substantially identical design. In other words, both sides of the mechanical spring device are equipped in an identical manner or substantially identical manner with the switching function by means of switching sections. This leads to the outlay on regulation being reduced since a regulating signal can preferably be received on both sides in an identical manner. Furthermore, by means of the design on both sides, a correspondingly larger movement clearance is possible if the force absorption is substantially switched off. This leads to the pneumatic suspension system being able to provide the pneumatic suspension functionality in the comfort mode for a wider movement clearance without an interfering action of the arranged mechanical spring device.

It is furthermore advantageous if, in the case of a chassis device according to aspects of the invention, the at least one switching section has a sensor, in particular for measuring force, for determining the force absorption at the associated countersection. Such a sensor then permits the current switching state and therefore the effect of the set switching situation to be checked and therefore to make same accessible for regulation. Such a sensor makes it possible to determine the force absorption, for example depending on the suspension system situation. If the sensor is scanned for a defined period of time and it is correspondingly determined that there is no force absorption whatsoever during said period of time, this indicates the fact that the mechanical spring device has been removed from the force path. The switching state OFF is therefore involved for the switching section. If, in contrast thereto, a switching state ON is predetermined for the switching section, it should be anticipated and therefore also checked that a force absorption can be identified at the sensor. In addition to a purely qualitative switching between two switching states, a regulation and therefore a quantitative monitoring of the switching states with a sensor of this type can of course also be provided.

It is likewise advantageous if, in the case of a chassis device according to aspects of the invention, the switching section can assume at least three different variation forms in respect of the variation of the force absorption, in particular in that the variation of the force absorption by the switching section can take place continuously and/or in an infinitely variable manner. The variation in the force absorption or the corresponding variation form may also be referred to as switching state of the switching section. The more different switching states can be made available, the greater is the flexibility during use of a chassis device according to aspects of the invention. In addition to the purely qualitative switching of the switching section on and off, it is thereby possible also to provide a quantitative adaptation and therefore a selective and partial switching on of the mechanical spring device. A shifting, in particular continuously, between a sports setting and a comfort setting therefore essentially takes place instead of a rigid switching over of the chassis settings.

The subject matter of the present invention is likewise a method for changing the chassis characteristics of a chassis of a vehicle with at least one chassis device, in particular designed according to the present invention, with a pneumatic suspension system, having the following steps:
identifying a switching-over requirement,
varying the force absorption for a connecting section of a mechanical spring device in a pneumatic chamber of the pneumatic suspension system by means of a switching section of a countersection of the pneumatic chamber.

By using a chassis device according to aspects of the invention, a method according to aspects of the invention affords the same advantages as have been explained in detail with regard to a chassis device according to aspects of the invention. The identification of the switching-over requirement can take place here in a very wide variety of ways.

Firstly, this can be an active user requirement, the user carrying out a corresponding active switching over between different chassis settings. However, automated switching-over operations are fundamentally also conceivable in order to be able to activate the switching over depending on driving parameters of the vehicle.

A method according to aspects of the invention can be developed to the effect that an identical variation of the force absorption is carried out at least for two chassis devices of the wheel suspensions of a pair of axles. A pair of axles is, for example, the sum total of the wheel suspensions of the two rear wheels or of the wheel suspensions of the two front wheels. A defined different distribution, as far as the different chassis characteristics are concerned, can therefore be provided between front wheels and rear wheels. An identity is produced here in respect of the chassis characteristics of a pair of axles on the left and right such that an undesirable situation of the vehicle swerving can be avoided with a high degree of probability. In particular, a differentiation is made here between an active and a passive axle with regard to the drive of the corresponding axle.

### BRIEF DESCRIPTION OF THE DRAWINGS

Further advantages, features and details of the invention will become apparent from the description below, in which exemplary embodiments of the invention are described in detail with reference to the drawings. The features mentioned in the claims and in the description may be essential to the invention in each case individually by themselves or in any combination. In the drawings, schematically:

FIG. 1 shows an embodiment of a chassis device according to aspects of the invention,

FIG. 2 shows a further embodiment of a chassis device according to aspects of the invention,

FIG. 3 shows the embodiment of FIG. 2 with switching section switched off,

FIG. 4 shows the embodiment of FIGS. 2 and 3 with switching section switched on, and

FIG. 5 shows the embodiment of FIGS. 2 to 4 with switching section switched on, under spring loading.

### DETAILED DESCRIPTION OF THE INVENTION

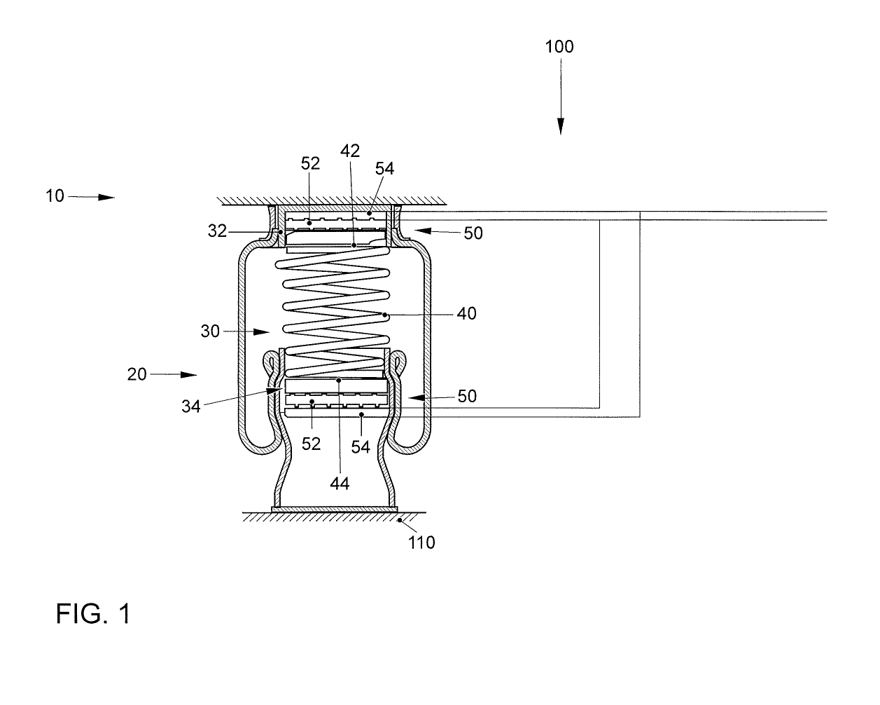

FIG. 1 shows schematically a chassis device 10 according to aspects of the invention which is equipped with a pneumatic suspension system 20. The comfortable functionality of the pneumatic suspension system 20 is provided by a pneumatic spring chamber 30 which can be pressurized with compressed air in order to provide the spring comfort.

In order to be able to provide the switching over according to aspects of the invention between steel spring chassis characteristics and pneumatic spring chassis characteristics, a mechanical spring device 40 in the form of a spiral spring is arranged as a steel spring within the pneumatic chamber 30. Said mechanical spring device 40 has two connecting sections 42 and 44 which are supported at the top and bottom against corresponding countersections 32 and 34 of the pneumatic chamber 30. It can already be seen in this situation that a dedicated switching section 50 is provided in each case for the two countersections 32 and 34, said switching sections 50 each having a switching space 52. The switching space 52 in each case contains a magnetizable liquid, the ferromagnetic particles of which can change the elasticity within said switching space 52 depending on an effective magnetic field. In order to generate said magnetic field, electromagnetic coils 54 which can be activated by a common current supply and/or by a common monitoring unit are provided for each switching section 50.

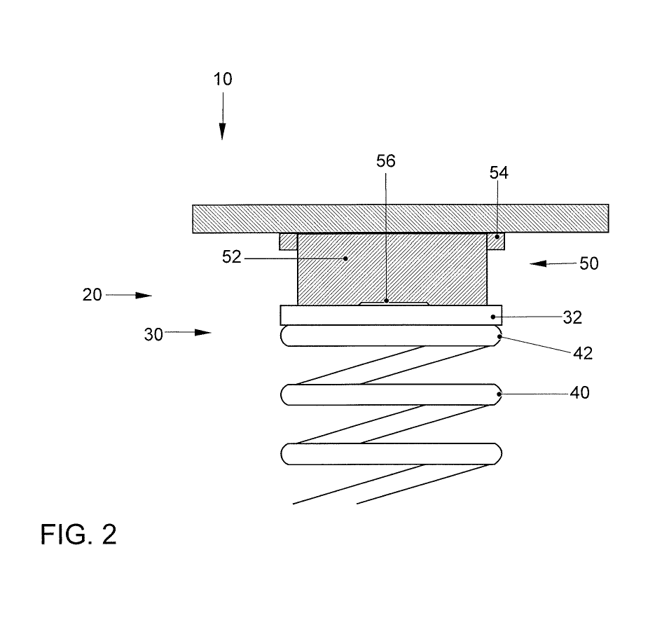

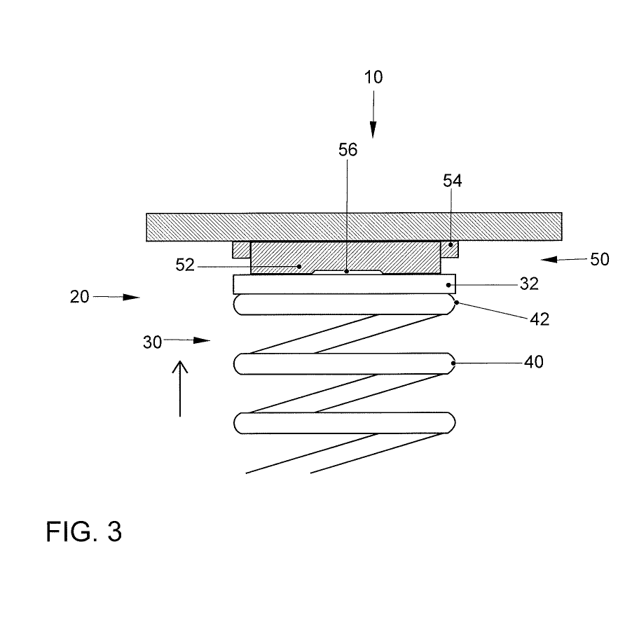

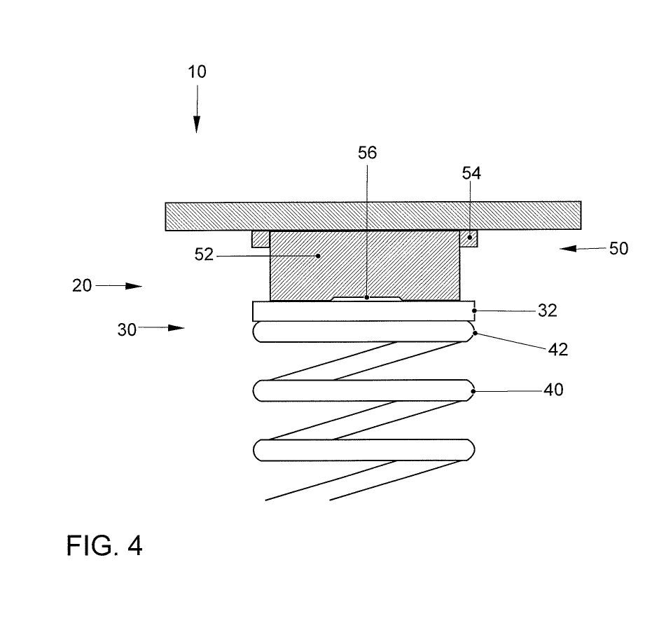

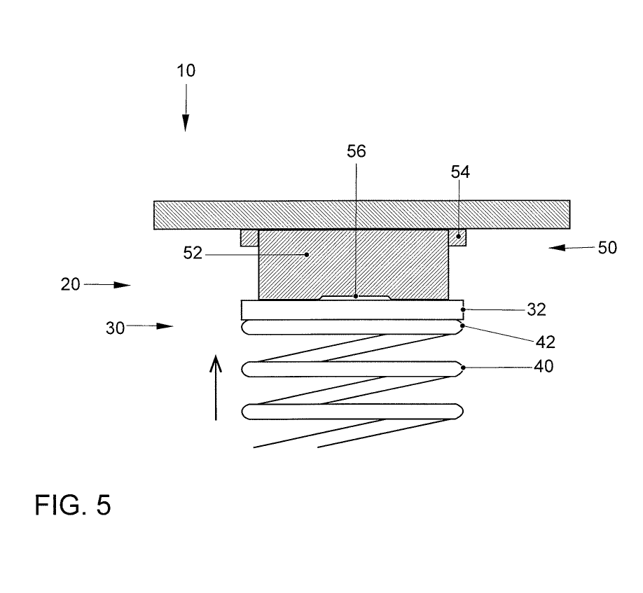

The manner of operation in the different switching modes will now be explained in more detail with reference to FIGS. 2 to 5. FIGS. 2 to 3 show a situation with switched-off steel spring characteristics, while FIGS. 4 and 5 provide switched-on steel spring characteristics for the chassis 100. FIGS. 2 and 3 show a switching space 50 which is filled with ferromagnetic particles in a magnetizable liquid. A magnetic field can be applied via an encircling electromagnetic coil 54, but said magnetic field is missing in the situation in FIGS. 2 and 3. In this situation, in the event of action of a force in the arrow direction according to FIG. 3, the switching space 52 will collapse, for example by flexible walls of the switching space 52 yielding since no resistance force can be provided by the magnetizable fluid. As is apparent from FIG. 3, the mechanical spring device 40 therefore remains substantially unloaded, and therefore a corresponding pressure sensor 56 does not output any acknowledgement whatsoever and therefore a force absorption substantially equal to zero is output.

If the user of a vehicle switches over from comfort mode to sports mode, current is applied to the electromagnetic coil 54 and an electromagnetic field thereby forms. As FIGS. 4 and 5 show, this leads to an alignment or crosslinking of the ferromagnetic particles and thereby to stiffening of the magnetizable fluid in the switching space 52. The switching section 50 thereby exhibits the switching state ON, and therefore, in the event of an action of a force in the arrow direction according to FIG. 5, the force is now also or exclusively supported via the mechanical spring device 40 and the latter is deformed mechanically. The spring characteristic of the mechanical spring device 40 therefore arises for the chassis. Accordingly, in this situation, a force absorption can be perceived at the sensor 56.

The above explanation of the embodiments describes the present invention exclusively within the context of examples. Of course, individual features of the embodiments can be freely combined with one another, if technically expedient, without departing from the scope of the present invention.

What is claimed is:

1. A chassis device for a suspension system of a wheel suspension of a chassis of a vehicle, said chassis device comprising:
a pneumatic suspension system with a pneumatic spring chamber for receiving compressed air,
a mechanical spring device arranged in the pneumatic spring chamber, and having a first connecting section, which is supported against a first countersection of the pneumatic spring chamber, and the mechanical spring device also having a second connecting section, which is supported against a second countersection of the pneumatic spring chamber,
wherein at least one of the two countersections has a switching section for varying a force absorption by the connecting section.

2. The chassis device as claimed in claim 1, wherein the mechanical spring device is a spiral spring.

3. The chassis device as claimed in claim 1, wherein the at least one switching section has a switching space which is filled with a fluid having a variable elasticity.

4. The chassis device as claimed in claim 3, wherein the fluid is a magnetizable liquid having ferromagnetic particles, and, wherein, under the effect of a magnetic field, the ferromagnetic particles are aligned which changes the elasticity of the magnetizable liquid.

5. The chassis device as claimed in claim 4, wherein the at least one switching section has an electromagnetic coil device for generating a magnetic field for affecting the magnetizable liquid accommodated in the switching space.

6. The chassis device as claimed in claim 1, wherein each of the countersections has a dedicated switching section, wherein the switching sections are of either identical or substantially identical design.

7. The chassis device as claimed in claim 1, wherein the at least one switching section has a sensor for measuring force and for determining a force absorption at the associated countersection.

8. The chassis device as claimed in claim 1, wherein the switching section assumes at least three different variation forms with respect to the variation of the force absorption, wherein the variation of the force absorption by the switching section takes place continuously and/or in an infinitely variable manner.

9. A method for changing chassis characteristics of a vehicle chassis of a vehicle having at least one chassis device and a pneumatic suspension system, the method comprising the steps of:
(a) identifying a switching-over requirement, and
(b) varying a force absorption for a connecting section of a mechanical spring device in a pneumatic chamber of the pneumatic suspension system by a switching section of a countersection of the pneumatic chamber.

10. The method as claimed in claim 9, wherein an identical variation of the force absorption is carried out at least for two chassis devices of the wheel suspensions of a pair of axles.
